(19) United States
(12) Patent Application Publication
(10) Pub. No.: US 2009/0194221 A1
(43) Pub. Date: Aug. 6, 2009

(54) METHOD FOR MANUFACTURING BALL WITH COLOR IMPRESSION

(76) Inventor: TIAN-LAI CHENG, Taichung (TW)

Correspondence Address: LEONG C LEI, PMB # 1008, 1867 YGNACIO VALLEY ROAD, WALNUT CREEK, CA, 94598, US

(21) Appl. No.: 12/023,038

(22) Filed: Jan. 31, 2008

(51) Int. Cl. B29C 65/08; B29C 45/00

(52) U.S. Cl. 156/73.1; 264/328.14; 156/245; 264/132

(57) ABSTRACT

Disclosed is a method for manufacturing a ball with color impression. The ball includes an inflatable bladder, which is enclosed by a reinforcement layer and further wrapped by a body layer and a color composite sheet. The method includes a process for making the color composite sheet, which include a step of making a color film, which is made of a porous material having minute pores and on which a pattern is printed, with the pores maintained after printing, and a step for making a transparent layer, which is made by heating a material for making the transparent layer into a flowable liquid form for filling into the pores of the color film to form the color composite sheet, wherein the printed pattern that is formed on the color film is observable through the transparent layer.

### BACKGROUND OF THE INVENTION

(a) Technical Field of the Invention

The present invention relates to a method for manufacturing a ball with color impression, wherein a pattern is printed on a porous material to form a color film and a material for making a transparent layer is heated into a flowable liquid form and further injected onto the color film to bond thereto by an injection-molding device, or the material for making the transparent layer is positioned on the color form and is further heated and pressed by a hot pressing device or an ultrasonic processing device to have the material filled into pores of the porous material of the color film to thereby form a color composite sheet, which is then cut to proper sizes for combination or bonding to a surface of a ball blank with the color pattern being observable through the outermost transparent layer.

(b) Description of the Prior Art

Sports balls, such as basket balls, soccer balls, volley balls, hand balls, foot balls, American foot balls, and toy balls, can be made with either hand-sewing process or non-hand-sewing process. For the non-hand-sewn ball, further classification can be made in view of the structure thereof as having wrapped layer and having no wrapped layer. For a ball with wrapped layer, it can be further divided into hand-pasting and rubber forming. For a conventional ball to add a surface impression, due to the constrains of the material of the surface layer of the ball and the spherical shape of the ball, the methods that can be used to print a ball are limited, such as screen printing and transfer printing for forming pattern on a piece of natural leather or synthetic lather, followed by ultrasonic or hot-stamping processing to have the patter embossed. Then the piece can be attached to the surface of the ball. Or, the desired pattern is first printed on a piece of cellophane or polyester film and the film is attached to an outer rubber layer, before the rubber is vulcanized. Then the outer rubber layer is attached to a ball blank with the pattern exposed on the outside. The ball is then positioned in mold comprising two hemispherical mold members for heating, pressurizing, and vulcanizing. Thereafter, the cellophane or polyester film is removed and the color pattern is left on the rubber layer that constitutes the outer layer of the ball. As such, a rubber having a color pattern on an outer surface thereof is formed.

The above described methods are effective to form printings on the surface of a ball, but they still have drawbacks:

(1) The pattern is formed on the outermost layer of a ball and will fade or even disappear with the use of the ball.

(2) The pattern that is printed on the rubber layer or the cellophane film is subjected to the constraint of traditional screen printing, of which the resolution and quality are heavily dependent upon human intervention and often leading to poor and inelegant pattern quality and insufficiently clear colors.

(3) Discontinuity often occurs in surface texture, pattern, and color of the ball, leading to poor visual effect.

(4) The known methods are complicated processes, which lead to increase of costs.

To improve such problems, it has been proposed to interpose a color pattern between a ball blank and an outer transparent layer to overcome the problems of wear resistance and background color of rubber. Examples include U.S. Pat. Nos. 5,320,345 and 5,649,701. These known techniques are first printing or transferring a color pattern onto an outer surface of a transparent rubber sheet and then covering the transparent rubber sheet, together with the color pattern, over a ball blank, both being then deposed in a mold for heating to form a ball having a color pattern protected by a transparent cover layer. These techniques partially overcome the drawbacks of the conventional color-patterned balls, but they still suffer certain their own drawbacks:

(1) The color pattern is directly printed on the transparent rubber sheet by screen printing, which does not allow for a resolution as high as three million pixel and thus cannot provide a color pattern having a quality resembling that of a photo.

(2) It is hard to carry out printing or transferring to a rubber sheet in an automatic manner and manual operation is needed to print the rubber sheet in a one piece by one piece manner, this leads to high costs and this is especially true for multiple color printing, whereby the quality cannot be well controlled and mass production is impossible.

(3) It is not possible to make printing on a large surface or spherical surface so that except the portion on which the printed pattern is present, the ball, when observed from outside, can be directly viewed into the internal wrapped layer through the transparent, but not-printed portion of the ball, making the ball look ugly.

(4) The operation is complicated and troublesome.

### SUMMARY OF THE INVENTION

The primary purpose of the present invention is to provide a method for manufacturing ball with color impression, of which an objective is to ensure mass and efficient production of balls that have transparent layer of color pattern with high quality and high resolution.

The ball made in accordance with the method of the present invention comprises an inner blade enclosed by a reinforcement layer with a color composite sheet wrapping around an outer surface of the reinforcement layer. The color composite sheet is made by the following steps:

(1) A base material is selected, which base material is a printable material on which a color pattern can be printed and which, after added with additives, forms a porous material having plenty of minute pores.

(2) Offset printing or gravure printing is employed to realize automatized and high-quality printing for forming the color pattern on the porous material to thereby form a color film that features porosity.

(3) A material for making a transparent layer is selected, which can be either plastics or rubber and which is heated into a flowable liquid form for filling into the pores of the color film.

(4) The color film is then disposed in a mold and the material for making the transparent layer is heated into a flowable liquid form and injected onto the color film, or the plastic or rubber material for making the transparent layer is positioned on the color film and is heated by a hot pressing device or an ultrasonic processing device to have the liquid material filled into the pores of the color film whereby the transparent layer is securely bonded to the color film after being cured with no bonding agent used to form a color composite sheet of a thickness between 0.05-3.0 mm.

Instead of directly printing a pattern on the surface of a ball or separately making a transparent layer, followed by printing a pattern on a back surface of the transparent layer that are employed in the conventional techniques, the present invention provides a process for making a color composite sheet, which can be bonded to the surface of a ball in different ways in accordance with the type of the ball, such as half-ball mold vulcanization, sewing, and adhesives, and which is applicable to an elliptic ball that is used in American foot ball games, those ball being made with the conventional techniques. The color pattern is integrated to the underside of the transparent layer and apparently, only the surface of the transparent layer is subjected to wearing and touch when the ball is played so that the color pattern will not be damaged to any extent. Further, since the color film has the property that is suitable for regular printing, automatized manufacturing is possible, and image processing for gradually layer changing or multiple layers is available for the color pattern, both leading to versatility of the printed pattern. This cannot be realized in one printing step by the conventionally adopted screen printing, which lacks of precise control of printing quality. Further, since the color film is made of materials featuring porosity, the color film can be easily bonded to the transparent layer without using any bonding agent. All these together allow for forming patters having a resolution high up to three million pixels in a simple process and low costs.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF TEE DRAWINGS

FIG. 1 is a chart flow illustrating for a process making a color film in accordance with the present invention;

FIG. 2 is a flow chart illustrating a process for making a color composite sheet in accordance with the present invention;

FIG. 3 illustrates the color composite sheet, partially broken to illustrate inside details, of the present invention; and

FIG. 4 illustrates a ball manufactured in accordance with the present invention, a portion of the ball being broken to illustrate inside details.

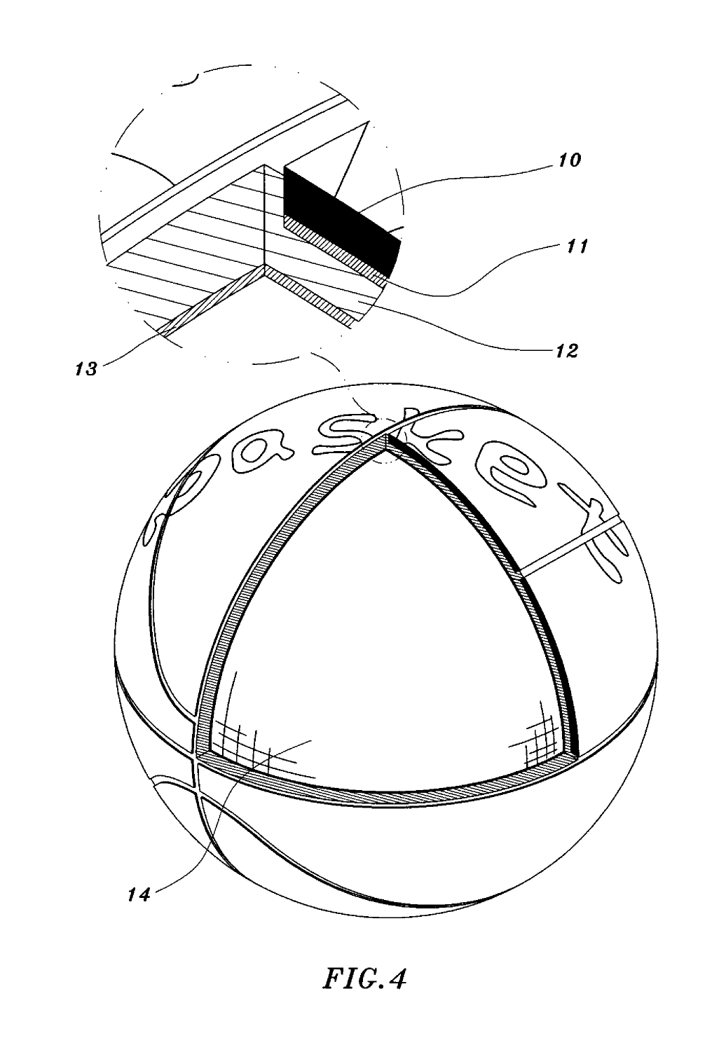

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

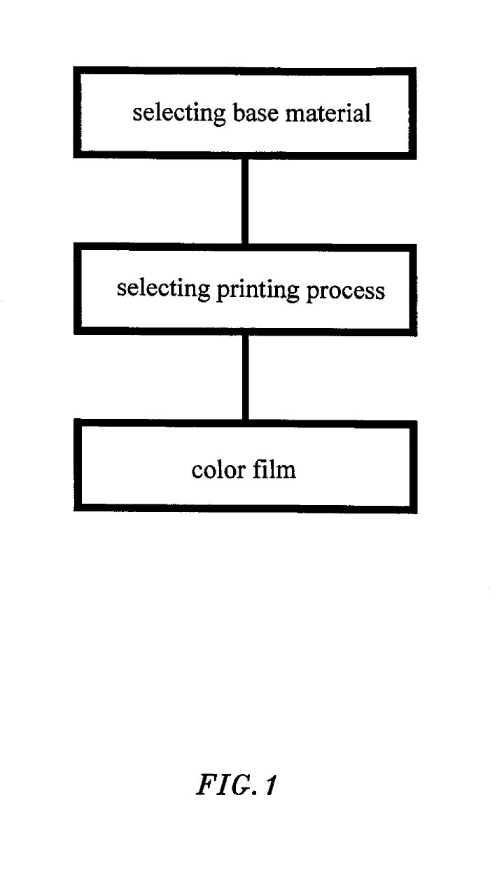

As shown in FIG. 1, which illustrates a flow chart for making the color film in accordance with the present invention, a base material is first selected. The base material is a porous material that contains a plurality of small pores and is capable of being printed with high resolution color patterns or impression with automatic printing process. The pores are of a size of 1 to 100 microns and can be filled with heated and molten plastics in liquid form for forming the transparent layer. The next is to select a printing process, which is selected in accordance with the desired resolution and costs and can be for example offset printing or gravure printing, by which color pattern or impression is printed on the porous material to thereby form a porous color film 11.

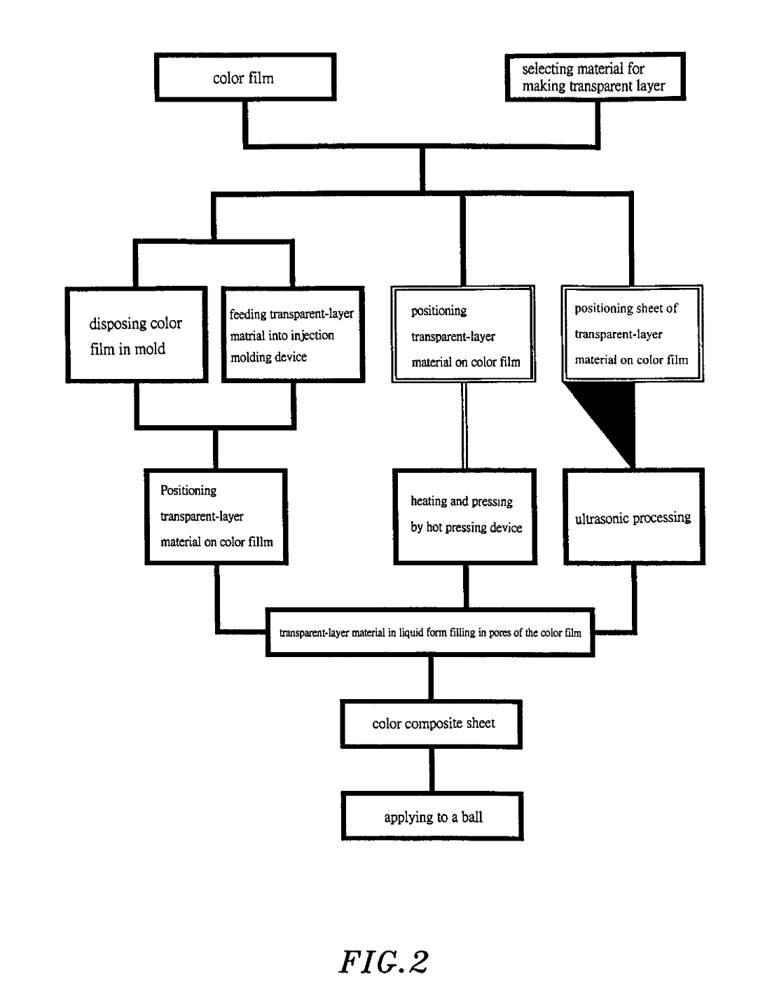

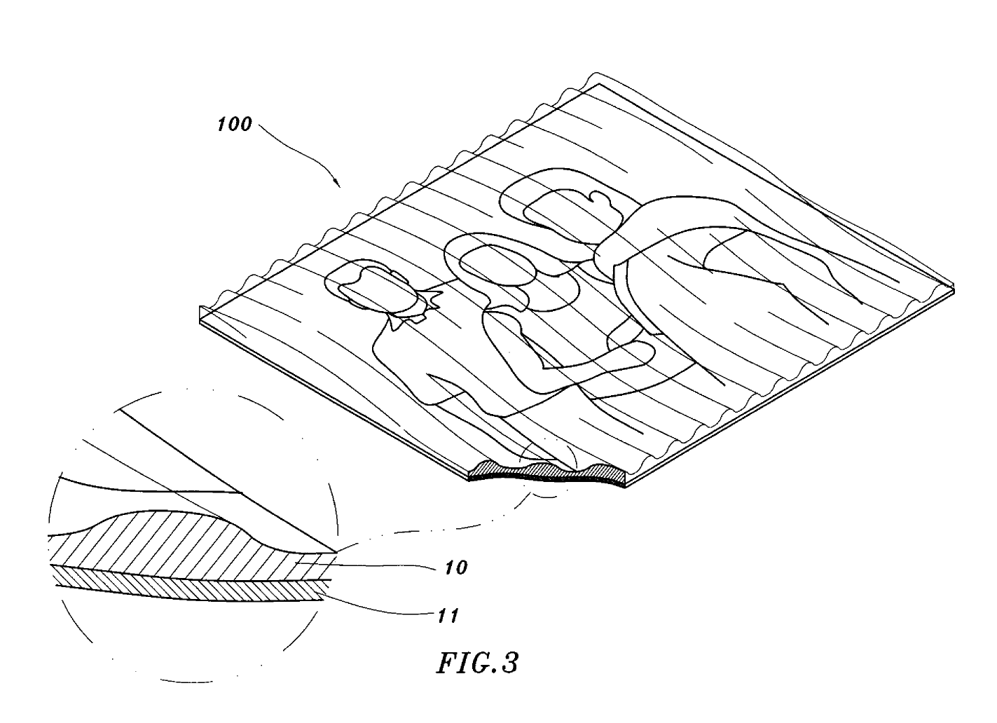

Referring to FIG. 2, which shows a flow chart for making the composite sheet in accordance with the present invention, and also with reference to FIG. 3, after the color film 11 is formed, a plastic material for making the transparent layer is selected and one of the following three processes can be selected for combining the transparent layer to the color film 11. The first process for combining operation is to put the color film 11 in a mold and feed the transparent-layer plastic material into an injection molding machine to have the transparent-layer plastic material heated to a molten and flowable condition and injected onto the color film 11. The molten transparent-layer plastic material, which is in liquid form, can fill into the minute pores of the color film 11. And after the molten transparent-layer plastic material cures, the color composite sheet 100 is completed. Further, an upper die that is physically engageable with the transparent-layer plastic material is formed with or is engraved with a pattern so that when the transparent-layer plastic material cures, the color composite sheet 100 so formed exhibits three-dimensional embossed visual effect, as demonstrated in FIG. 3.

The second process for the combining operation is to put the material used to form the transparent layer, which as an example in the second process is transparent rubber, on the color film and subjected to heating and pressing by a hot press to force the rubber to fill into the minute pores of the color film 11. At the same time, the rubber is subjected to cross-linking and vulcanization to a desired vulcanization degree and thus the color composite sheet 100 is completed.

The third process for the combining operation is to put a plastic sheet that is to form the transparent layer on the color film 11 and copper dies of an ultrasonic processing machine are used to pressurize the two layers to have the plastic material filled into the minute pores of the color film 11 to thereby complete the color composite sheet 100. Again, similar to what discussed in the first process for combining operation, the copper die that is engageable with the plastic material is formed with or is engraved with a pattern or other shapes so that when the transparent-layer plastic material cures, the color composite sheet 100 is formed as shown in FIG. 3.

Three illustrative processes for combining operation are described above and it is known that different process can be selected or performed with respect to different materials. It is also known that all the processes used are generally based on the porosity of the color film 11 by which transparent-layer plastic material or the transparent rubber can be directly attached to and coated on the color film 11. In the combining process, no bonding agent is added to firmly fix the transparent layer 10 and the color film 11 together. The color composite sheet 100, after completed, can be cut to small pieces that can be combined or pieced together and/or sewn, bonded, or vulcanized to fix to an outer surface of a ball that is manufactured with conventional processes. The properties of the materials for making the color film 11 and the transparent layer 10 are described as follows:

(1) The porous material having pores can be of a base material that is printable, such as paper, synthetic paper, fiber fabric, and plastic films. The plastic films are made of for example polyethylene, polypropylene, polyethylene terephalate (PET), thermoplastic urethane (TPU), polyvinylchloride (PVC), and thermoplastic elastomer (TPE), but not limited thereto.

(2) The material for the transparent layer can be for example polyvinylchloride (PVC), styrene-butadiene-styrene copolymer (SBS), styrene-isoprene-styrene copolymer (SIS), styrene-ethylene-butylenes-styrene copolymer (SEBS), styrene-ethylene-propylene-styrene copolymer (SEPS), polyolefin elastomer (POE), ethylene-propylene rubber (EPR), ethylene-propylene-diene rubber (EPDM), butadiene rubber (BR), solution styrene-butadiene rubber (SSBR), isoprene rubber (IR), and polyurethane rubber (CUR), but not limited thereto. If the transparent layer needs vulcanization, then peroxides or cross-linking resin can be added as bridging agent or cross-linking agent before the combining operation starts. The peroxides that are used here can be for example di cumyl peroxide (DCP), benzo peroxide (BPO), and methyl ethyl ketone peroxide (MEKPO), but not limited thereto and the quantity of the peroxides added is around 0.1-8 phr (parts per hundred resin).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for manufacturing a ball that is comprised of an inflatable bladder, which is enclosed by a reinforcement layer and further wrapped by a body layer and a color composite sheet, the method comprising a process for making the color composite sheet, which comprises a step of making a color film, which is made of a porous material having minute pores and on which a pattern is printed, with the pores maintained after printing, and a step for making a transparent layer, which is made by heating a material for making the transparent layer into a flowable liquid form for filling into the pores of the color film to form the color composite sheet, wherein the printed pattern that is formed on the color film is observable through the transparent layer.

2. The method as claimed in claim 1, wherein the step for making the transparent layer comprises disposing the color film in a mold and a step of heating and injecting the material for making the transparent layer onto the color film by an injection molding device.

3. The method as claimed in claim 1, wherein the step for making the transparent layer comprises a material for making the transparent layer on the color film and heating and pressing the material to bond to the color film by a hot pressing device.

4. The method as claimed in claim 1, wherein the step for making the transparent layer comprises a material for making the transparent layer on the color film and using a die of an ultrasonic processing device to heat and pressurize the material to bond to the color film by an ultrasonic processing device.

5. The method as claimed in claim 1, wherein the step for making the color film comprises printing the pattern on the porous material by offset printing.

6. The method as claimed in claim 1, wherein the step for making the color film comprises printing the pattern on the porous material by gravure printing.

7. The method as claimed in claim 2, wherein a mold is used to injection-mold the transparent layer, a pattern being formed on a surface of the mold engageable with the transparent layer.

8. The method as claimed in claim 4, wherein the die of the ultrasonic processing device is formed with a pattern on a surface thereof engageable with the transparent layer.

9. The method as claimed in claim 1, wherein the porous material for making the color film is selected from a group consisting of paper, synthetic paper, fiber fabric, and plastic film, the plastic film being made of a material selected from a group consisting of polyethylene, polypropylene, polyethylene terephthalate (PET), thermoplastic urethane (TPU), polyvinylchloride (PVC), and thermoplastic elastomer (TPE).

10. The method as claimed in claim 1, wherein the material for making the transparent layer is selected from a group consisting of polyvinylchloride (PVC), styrene-butadiene-stryene copolymer (SBS), stryene-isoprene-styrene copolymer (SIS), styrene-ethylene-butylenes-styrene copolymer (SEBS), styrene-ethylene-propylene-styrene copolymer (SEPS), polyolefin elastomer (POE), ethylene-propylene rubber (EPR), ethylene-propylene-diene rubber (EPDM), butadiene rubber (BR), solution styrene-butadiene rubber (SSBR), isoprene rubber (IR), and polyurethane rubber (PUR).
